(19) United States
(12) Patent Application Publication
(10) Pub. No.: US 2019/0377875 A1
(43) Pub. Date: Dec. 12, 2019

(54) Image Processing Device and Method for Controlling the Same

(71) Applicant: KONICA MINOLTA, INC., Tokyo (JP)

(72) Inventors: Shinya HASHIMOTO, Nishinomiya-shi (JP); Katsuhiko AKITA, Amagasaki-shi (JP)

(73) Assignee: KONICA MINOLTA, INC., Tokyo (JP)

(21) Appl. No.: 16/430,531

(22) Filed: Jun. 4, 2019

(30) Foreign Application Priority Data
Jun. 8, 2018 (JP) 2018-110311

(51) Int. Cl. G06F 21/56; H04N 1/00

(52) U.S. Cl. CPC G06F 21/561; G06F 21/564; G06F 21/567; G06F 2221/034; H04N 1/00058; H04N 1/00087; H04N 1/00915; H04N 1/00037

(57) ABSTRACT

An image processing device includes a memory storing a file, and a circuitry configured to execute virus scan on the file stored in the memory. The memory stores information on priority levels set for one or more functions of the image processing device. The circuitry is configured to determine a timing to execute the virus scan in accordance with the priority levels upon receipt of a request for execution of the virus scan and the one or more functions in parallel.

Japanese Patent Application No. 2018-110311 filed on Jun. 8, 2018, including description, claims, drawings, and abstract the entire disclosure is incorporated herein by reference in its entirety.

### BACKGROUND

### Technological Field

The present disclosure relates to a timing to start virus scan in an image processing device.

### Description of the Related Art

In recent years, image processing devices such as MFP (Multi-Functional Peripheral), have a function of connecting to networks. Therefore, virus scan is executed even in image processing devices to securely avoid unintended data exfiltration onto the networks. Virus scan consumes resources such as a processor. Due to this, the performance of the image processing device is degraded during the execution of the virus scan, as with personal computers, etc., and a situation may take place where the image processing device cannot provide its intended functions, such as the print function.

For general information processing devices, conventionally, various technologies are proposed against the degradation in performance due to execution of virus scan. For example, Japanese Laid-Open Patent Publication No. 2012-141839 discloses a monitor station which requires authorization from a user to start virus scan. Japanese Laid-Open Patent Publication No. 2009-064271 discloses a technology in which information processing device, which includes multiple discs, executes virus scan in a period in which one of the discs is not being used, or a period in which disk utilization is below the threshold. Japanese National Patent Publication No. 2015-508927 discloses a technology of executing virus scan during an idle time of the system.

### SUMMARY

While there are various proposals made for general information processing devices as described above, a timing to start the virus scan in an image processing device still requires considerations.

According to a certain aspect of the present disclosure, an image processing device is provided. The image processing device includes a memory for storing a file; and a circuitry configured to execute a virus scan on the file stored in the memory. The memory stores information on priority levels set to one or more functions of the image processing device. The circuitry is configured to determine a timing to execute a virus scan in accordance with the priority levels upon receipt of a request for execution of the virus scan and at least one of the one or more functions in parallel.

According to another aspect of the present disclosure, a method for controlling an image processing device is provided. The image processing device includes a memory storing a file, and a circuitry configured to execute a virus scan on the file stored in the memory. The method including: determining, by the circuitry, whether the image processing device receives a request for execution of the virus scan and at least one of one or more functions of the image processing device in parallel; when the image processing device receives the request for the execution of the virus scan in parallel with the at least one of the one or more functions, reading, by the circuitry, from the memory, information on priority levels set to the at least one of the one or more functions; and determining, by the circuitry, a timing to execute the virus scan in accordance with the priority levels.

According to still another aspect of the present disclosure, a non-transitory computer-readable recording medium is provided, the non-transitory computer-readable recording medium storing a computer program including an instruction for execution by a computer included in an image processing device which executes one or more functions. The image processing device includes a memory storing a file. The instruction causes the computer to perform: determining whether the image processing device receives a request for execution of virus scan and at least one of the one or more functions of the image processing device in parallel; when the image processing device receives the request for the execution of the virus scan and the at least one of the one or more functions in parallel, reading, from the memory, information on priority levels set to the at least one of the one or more functions; and determining a timing to execute the virus scan in accordance with the priority levels.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention.

FIG. 1 is a diagram showing an appearance of an image processing device according to the present disclosure.

FIG. 2 is a diagram showing a hardware configuration of the image processing device of FIG. 1.

FIG. 3 is a diagram illustrating an example functional configuration of a CPU 20.

FIG. 4 is a diagram illustrating an example of parallel execution availability information.

FIG. 5 is a flowchart for a process executed by CPU 20 (virus scan function 20B) when a request for execution of the virus scan occurs.

FIG. 6 is a flowchart for a process executed by CPU 20 when a request for execution of a function occurs during the execution of the virus scan.

FIG. 7 is a flowchart for a process executed by CPU 20 to resume the virus scan suspended at step S26.

FIG. 8 is a diagram illustrating an example of importance level information of each function.

FIG. 9 is a diagram for illustrating one example of a mode of execution of the virus scan based on the importance level information.

FIG. 10 is a diagram for illustrating another example of the mode of execution of the virus scan.

FIG. 11 is a diagram for illustrating still another example of the mode of execution of the virus scan.

### DETAILED DESCRIPTION OF EMBODIMENTS

Hereinafter, one or more embodiments of the present invention will be described with reference to the drawings. However, the scope of the invention is not limited to the disclosed embodiments.

Hereinafter, embodiments of an image processing device will be described, with reference to the accompanying drawings. In the description below, the same reference sign is used to refer to like parts and components, which are assigned the same name and have the same function. Thus, descriptions of these will not be repeated.

### 1. CONFIGURATION OF IMAGE PROCESSING DEVICE

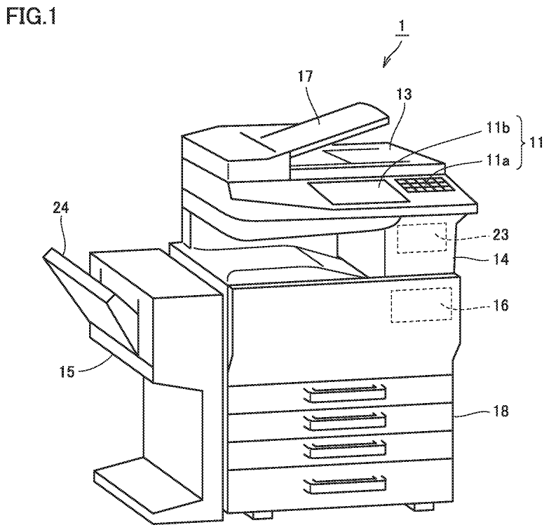

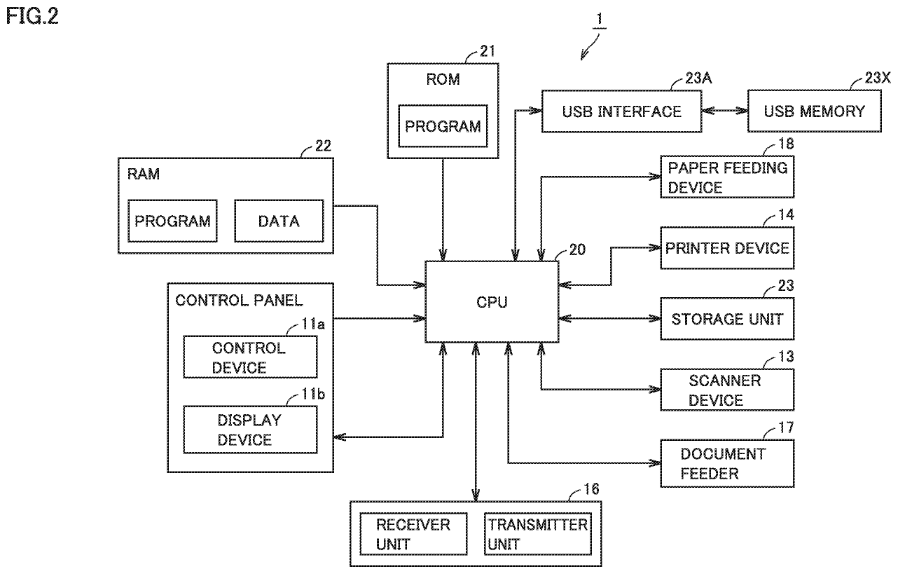

FIG. 1 is a diagram showing an appearance of an image processing device according to the present disclosure. FIG. 2 is a diagram showing a hardware configuration of the image processing device of FIG. 1.

One example of an image processing device 1 is an MFP, that is, a device into which functions, such as copying, network printing, scanner, a FAX machine, or a document server, are combined together. Image processing device 1 includes a control panel 11, a scanner device 13, a printer device 14, a finisher device 15, which executes processing such as stapling and punching, a communication interface 16, a document feeder 17, a paper feeding device 18, a CPU (Central Processing Unit) 20, a ROM (Read Only Memory) 21, a RAM (Random Access Memory) 22, a storage unit 23, and a USB (Universal Serial Bus) interface 23A.

CPU 20 is one example of circuitry which executes processing for implementing the functions of image processing device 1. Image processing device 1 may include dedicated hardware resources (such as ASIC: Application Specific Integrated Circuit) for executing the processing for implementing the functions, instead of or together with CPU 20.

Control panel 11 includes a control device 11a and a display 11b. Control device 11a includes multiple keys for inputting numerals, text, and symbols, etc., a comment key which is depressed by a user to create a post, a sensor which recognizes various keys depressed, and a circuitry for transmitting, to CPU 20, a signal indicating a recognize key.

Display 11b displays a screen for giving a message or an instruction, a screen for allowing the user to input details of settings and process content, and a screen for showing an image formed by image processing device 1 and a result of processing. Display 11b may be a touch panel. In other words, display 11b and at least part of control device 11a may be integrally configured. Display 11b has a function of sensing the location touched by the user with a finger on the touch panel, and transmitting a signal indicating a result of the sensing to CPU 20.

Image processing device 1 is communicable with an external device (e.g., personal computer) via communication interface 16. An application program for giving commands to image processing device 1 and a driver therefore may be install in the external device. This allows the user to remotely operate image processing device 1, using the external device.

Scanner device 13 photoelectrically scans image information, such as images, text, and pictures, from a document to obtain image data. The obtained image data (depth data) is converted into digital data at an image processing unit (not shown), subjected to well-known various image processing, sent to printer device 14 or communication interface 16, and either provided fro printing of the image or transmission of the data, or store in storage unit 23 for future use.

Printer device 14 prints image data obtained by scanner device 13, image data received from the external device through communication interface 16, or images stored in storage unit 23 onto recording sheets such as papers and films Paper feeding device 18 is provided in the lower portion of image processing device 1, and is used to feed, to printer device 14, a recording sheet that is appropriate for an image to be printed. The recording sheet having the image printed thereon by printer device 14, that is, a printed article passes through finisher device 15, subjected to the processing, such as stapling and punching, in accordance with a mode setting, and output to tray 24.

Communication interface 16 is a device, which includes a transmitter unit and a receiver unit, for exchanging data with PCs and FAX machines. One example of communication interface 16 is a NIC (Network Interface Card), a modem, or a TA (Terminal Adapter).

CPU 20 controls the entirety of image processing device 1, controlling the basic functions of image processing device 1, such as the communication function, the print function, the scanning function, a file transmission function, the browser function, etc.

ROM 21 is a memory storing operational programs for CPU 20, for example

RAM 22 is a memory for providing a work area for CPU 20 to operate in based on the operational programs. CPU 20 loads the operational programs and various data from ROM 21, etc., and works on the data.

Storage unit 23 is configured of, for example, a non-volatile storage device, such as a hard disk drive (HDD), and is storing various applications and image data of documents scanned by scanner device 13, etc.

USB interface 23A is an interface, for USB memory 23X, detachable from image processing device 1. CPU 20 reads information stored in USB memory 23X via USB interface 23A. CPU 20 also writes information into USB memory 23X via USB interface 23A.

### 2. FUNCTIONAL CONFIGURATION

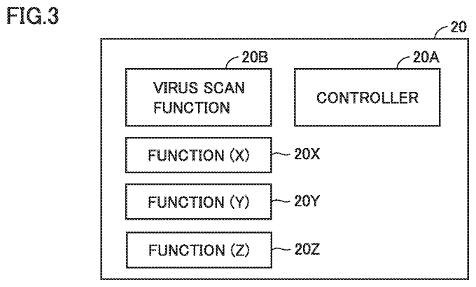

FIG. 3 is a diagram illustrating an example functional configuration of CPU 20.

As shown in FIG. 3, CPU 20 serves as a controller 20A, a virus scan function 20B, a function (X) 20X, a function (Y) 20Y, and a function (Z) 20Z. The respective functions are implemented, for example, by CPU 20 executing a program module corresponding to each function.

Controller 20A controls the operation of image processing device 1 to adjust a timing to start, interrupt, and resume jobs, for example. Virus scan function 20B executes virus scan on storage unit 23. This executes a virus check on each file within storage unit 23.

Function (X) 20X, function (Y) 20Y, and function (Z) 20Z are each for implementing a service provided by image processing device 1 to the user. Function (X) 20X controls scanner device 13, printer device 14, document feeder 17, and paper feeding device 18 to implement for example, the copy function. Function (Y) 20Y controls scanner device 13 and document feeder 17 to implement, for example, the scanning function. Function (Z) 20Z controls printer device 14 and paper feeding device 18 to implement, for example, the print function. Note that the number of and types of functions provided by image processing device 1 are not limited to those shown in FIG. 3.

### 3. PARALLEL EXECUTION AVAILABILITY INFORMATION

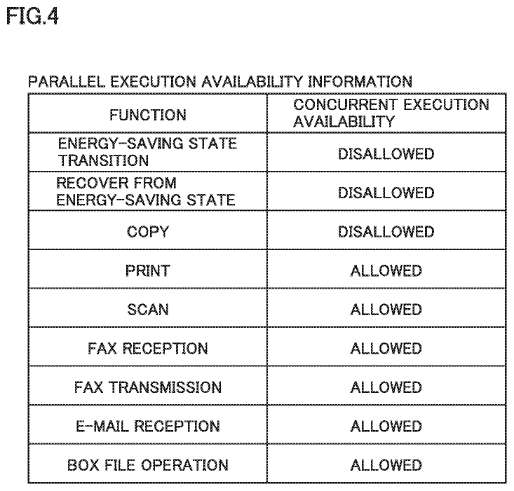

FIG. 4 is a diagram illustrating an example of parallel execution availability information. In the present embodiment, the parallel execution availability information is one example of information which defines a priority level which is set for each function of image processing device 1, and is stored in, for example, storage unit 23. The parallel execution availability information in FIG. 4 includes, as functions of image processing device 1, “energy-saving state transition,” “recover from energy-saving state,” “Fax reception,” “Fax transmission,” “E-mail reception,” “box file operation (operations on files stored in storage unit 23),” in addition to “copy,” “print,” and “scan” described with reference to FIG. 3. The “energy-saving state” refers to a standby state of image processing device 1 (a state in which supply of power to some of the elements included in image processing device 1 is ceased. Sleep mode.).

The parallel execution availability information associates each function with “allowed” or “disallowed.” The “allowed” represents that a function of image processing device 1 is allowed to be executed in parallel with the virus scan. The “disallowed” represents that the function of image processing device 1 is not allowed to be executed in parallel with the virus scan. In the example of FIG. 3, the “energy-saving state transition,” “recover from energy-saving state,” and “copy” are set to “disallowed,” and the other functions are set to “allowed.”

In image processing device 1, CPU 20 can update the settings (“allowed” or “disallowed”) of each function in the parallel execution availability information, in accordance with information input via control panel 11. This allows the user to adjust a mode of execution of each function. For example, if the user wishes to maintain constant productivity in copying by image processing device 1, the user updates the parallel execution availability information so as to raise the priority level of the copy function.

The parallel execution availability information may be set so that the priority levels of functions that guarantee given productivity of image processing device 1 are raised. For example, if the manufacturer guarantees that the copy function of image processing device 1 can process a given number of copies in a minute, the parallel execution availability information is set so that the priority level of the copy function is raised.

In the example of FIG. 3, “disallowed” corresponds to a high priority level, and “allowed” corresponds to a low priority level.

Preferably, functions related to image processing (the copy function, the print function, and the scanning function) are set to the high priority level. All or at least one of these three functions can be executed preferentially over the virus scan. In other words, CPU 20 may be configured so that at least one of the three functions is not executed in parallel with the virus scan.

In particular, preferably the copy function is set to the high priority level. The execution of the copy function is, often, started by the user directly operating image processing device 1. In other words, when the execution of the copy function is instructed, the user is, often, waiting for the completion of the copy function in front of the image processing device 1. In order not to increase such user stress, the priority level of the copy function can be set high.

### 4. PROCESS FLOW

### (Virus Scan Execution Request Process)

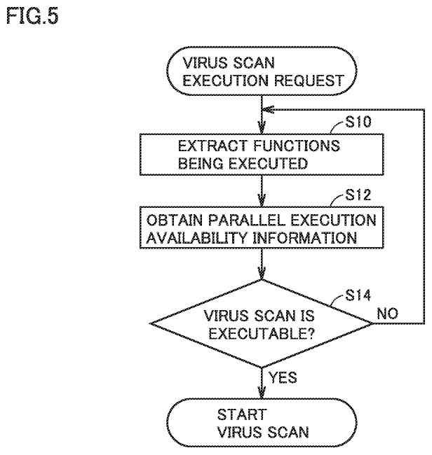

FIG. 5 is a flowchart for a process executed by CPU 20 (virus scan function 20B) when a request for execution of the virus scan occurs. The process in FIG. 5 is achieved by CPU 20 executing a given program. A request for execution of the virus scan occurs, for example, upon arrival of a pre-set time, a start request input to control panel 11, etc. Referring to FIG. 5, a flow of the process will be described.

At step S10, CPU 20 extracts functions being executed. In other words, CPU 20 identifies which function is currently being executed.

At step S12, CPU 20 queries the parallel execution availability information for information about the functions that are identified at step S10 as being executed.

At step S14, CPU 20 determines whether the virus scan is executable. In one example, CPU 20 determines that the virus scan is executable if all the functions that are identified at step S10 as being executed are associated with “permitted” in the parallel execution availability information, and determines that the virus scan is not executable if at least one of the functions is associated with “disallowed”. If CPU 20 determines that the virus scan is executable (YES at step S14), CPU 20 ends the process in FIG. 5 and starts the virus scan, and, otherwise (NO at step S14), returns the control back to step S10.

According to the process described with reference to FIG. 5, if there is a function already being executed when a request for execution of the virus scan occurs, CPU 20 waits for the parallel execution availability information for all the functions being executed to be changed to “permitted” or waits for all the functions being executed to end, and then starts the virus scan.

(Process upon Function Execution Request)

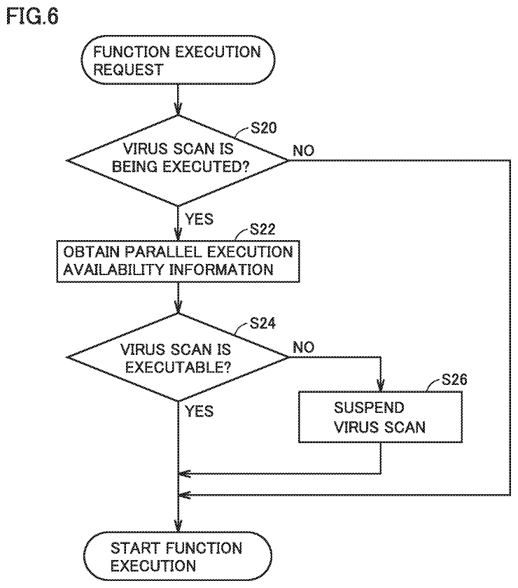

FIG. 6 is a flowchart for a process executed by CPU 20 when a request for execution of a function occurs during the execution of the virus scan. The process in FIG. 6 is started when a request for execution of a function occurs, and is implemented by CPU 20 executing a given program.

At step S20, CPU 20 determines whether virus scan is being executed. If CPU 20 determines that virus scan is being executed (YES at step S20), CPU 20 passes control to step S22, and, otherwise (NO at step S20), ends the process in FIG. 6 and starts the requested function.

At step S22, CPU 20 refers to the parallel execution availability information for the requested function.

At step S24, CPU 20 determines whether the requested function is associated with “allowed” in the parallel execution availability information. If CPU 20 determines that the requested function is associated with “allowed” (YES at step S24), CPU 20 ends the process in FIG. 6, and starts the requested function, and, otherwise (NO at step S24), passes control to step S26.

At step S26, CPU 20 suspends the virus scan, after which it ends the process in FIG. 6 and starts the requested function.

(Process upon Completion of Function Execution)

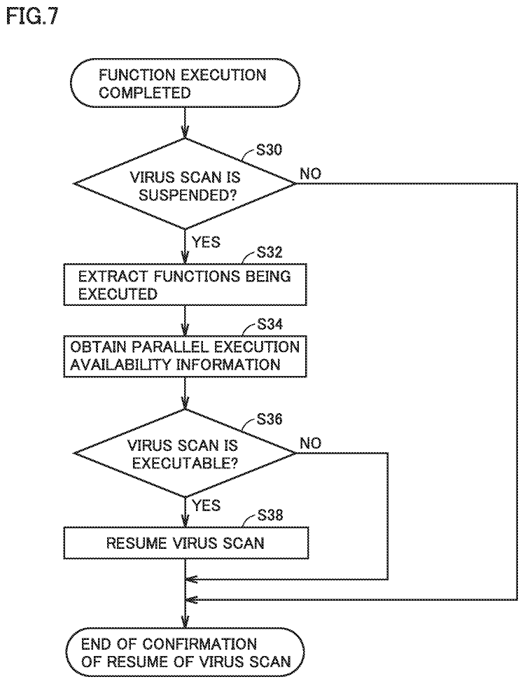

FIG. 7 is a flowchart for a process executed by CPU 20 to resume the virus scan suspended at step S26. The process in FIG. 7 is started upon, for example, the end of a function at image processing device 1. The process in FIG. 7 is implemented by, for example, CPU 20 executing a given program.

At step S30, CPU 20 determines whether the virus scan is suspended. In one example, CPU 20 may set a given flag (suspension flag) to suspend the virus scan at step S26. At step S30, CPU 20 may determine whether the suspension flag is set. If CPU 20 determines that the virus scan is suspended (YES at step S30), CPU 20 passes control to step S32, and, otherwise (NO at step S30), ends the process in FIG. 7.

At step S32, CPU 20 extracts functions being executed. For example, if the process in FIG. 7 starts after the print function and the scanning function are being executed and the scanning function only is then ended, the print function is extracted at step S32 as a function being executed.

At step S34, CPU 20 queries the parallel execution availability information for information about the function extracted at step S32.

At step S36, CPU 20 determines whether the virus scan is executable. For example, if all the functions extracted at step S32 are associated with “allowed” in the parallel execution availability information, CPU 20 determines that the virus scan is executable. For example, if at least one of the functions extracted at step S32 is associated with “disallowed” in the parallel execution availability information, CPU 20 determines that the virus scan is not executable. If CPU 20 determines that the virus scan is executable (YES at step S36), CPU 20 passes control to step S38, and, otherwise (NO at step S36), simply ends the process in FIG. 7. Then, as the function being executed ends, CPU 20 starts the process in FIG. 7 again.

At step S38, CPU 20 resumes the virus scan.

### 5. IMPORTANCE LEVEL INFORMATION

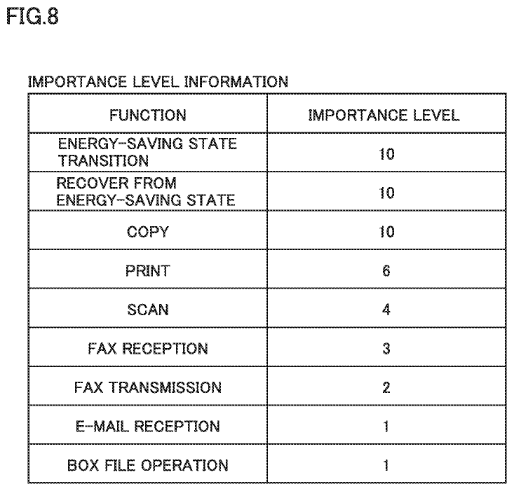

FIG. 8 is a diagram illustrating an example of importance level information of each function. The importance level information represents, in numeric, an importance level of each function in image processing device 1. In the example of FIG. 8, numeric values that are associated with the “energy-saving state transition,” “recover from energy-saving state,” and “copy” are 10. Moreover, the “print” is associated with 6, the “scan” is associated with 4, the “Fax reception” is associated with 3, the “Fax transmission” is associated with 2, and the “E-mail reception” and the “box file operation” are associated with 1.

CPU 20 may determine whether the virus check is executable, based on the importance level information, in addition to or instead of the parallel execution availability information. In one example, CPU 20 executes the virus check if the sum of importance levels of the functions being executed is less than “10”, and holds back from starting the virus check if the sum of the importance levels of the functions being executed is “10” or greater. In this example, “10” is one example of a threshold for the start of the virus check.

Preferably, the importance level information has a value greater than or equal to the threshold as an importance level of a function which guarantees the productivity of image processing device 1. This securely avoids execution of the function in parallel with the virus check. In one example, in image processing device 1, the productivity of the copy function is guaranteed, and the importance level information includes a value (10), the same value as the threshold, as an importance level of the copy function.

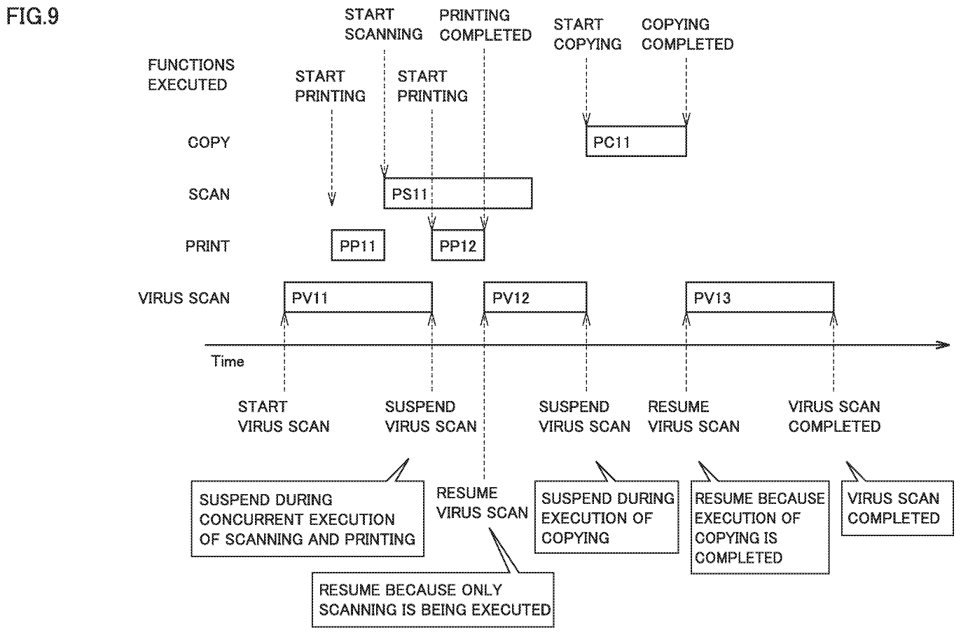

FIG. 9 is a diagram for illustrating one example of a mode of execution of the virus scan based on the importance level information. In FIG. 9, a process PV11 is shown as a virus scan process. FIG. 9 further shows a process PC11 as a process of the copy function, a process PS11 as a process of the scanning function, and processes PP11 and PP12 as processes of the print function.

Initially, CPU 20 starts process PV11 for the virus scan.

CPU 20 then starts process PP11 for printing. The print function has an importance level of “6”. There are no other functions being executed. Thus, the sum of importance levels at the time of start of process PP11 is “6”, which is less than the threshold “10.” For this reason, CPU 20 continues process PV11, resulting in process PP11 and process PV11 being executed in parallel.

After the end of process PP11, CPU 20 start s process PS11 for the scanning function. The scanning function has an importance level of “4.” There are no other functions being executed. Thus, the sum of importance levels at the time of start of process PS11 is “4”, which is less than the threshold “10.” For this reason, CPU 20 continues process PV11, resulting in process PS11 and process PV11 being executed in parallel.

CPU 20 then starts process PP12 for the print function during execution of process PS11. This amounts the sum of importance levels of the functions being executed to “10.” Therefore, CPU 20 suspends process PV11 for the virus scan.

After the completion of process PP12, CPU 20 resumes process PV11 for the virus scan. Process PS11 ends thereafter.

Thereafter CPU 20 starts process PC11 for the copy function. The copy function has an importance level of “10.” Thus, CPU 20 suspends process PV11 for the virus scan. After the end of process PC11, CPU 20 resumes process PV11.

### 6. EXAMPLE (1) IN WHICH VIRUS SCAN IS PREFERENTIALLY EXECUTED

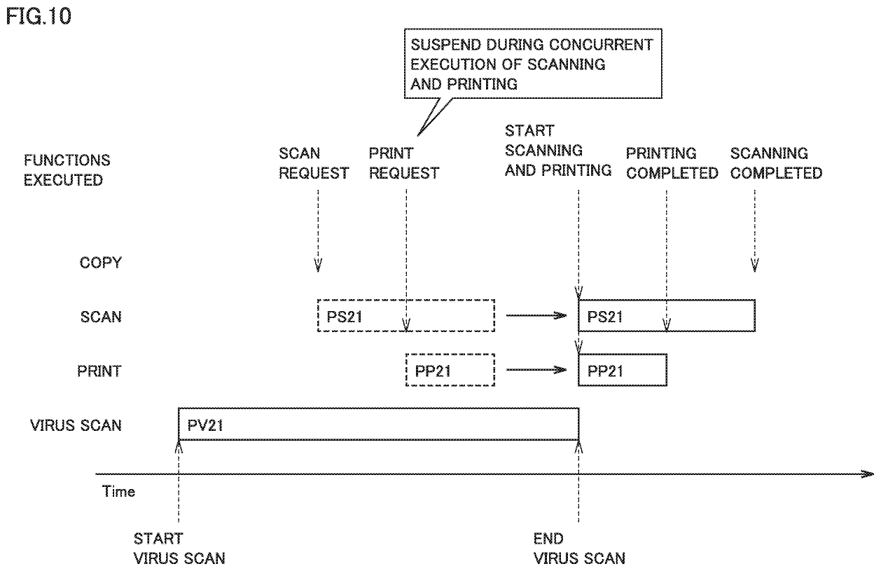

CPU 20 may prioritize the virus scan over any function under a given circumstance. FIG. 10 is a diagram for illustrating another example of a mode of execution of the virus scan. One example of the given circumstance is where the user sets image processing device 1 to prioritize the virus scan.

FIG. 10 shows a process PS21 for the scanning function, a process PP21 for the print function, and a process PV21 for the virus scan.

In the example of FIG. 10, initially, CPU 20 starts process PV21 for the virus scan. Then, since process PV21 is being executed, even if CPU 20 receives a scan request, CPU 20 delays the start of process PS21 for the scanning function in response to the request, until the end of process PV21 for the virus scan.

Moreover, since process PV21 is being executed, even if CPU 20 receives a print request, CPU 20 delays the start of process PP21 for the print function, until the end of process PV21 for the virus scan.

### 7. EXAMPLE (2) IN WHICH VIRUS SCAN IS PREFERENTIALLY EXECUTED

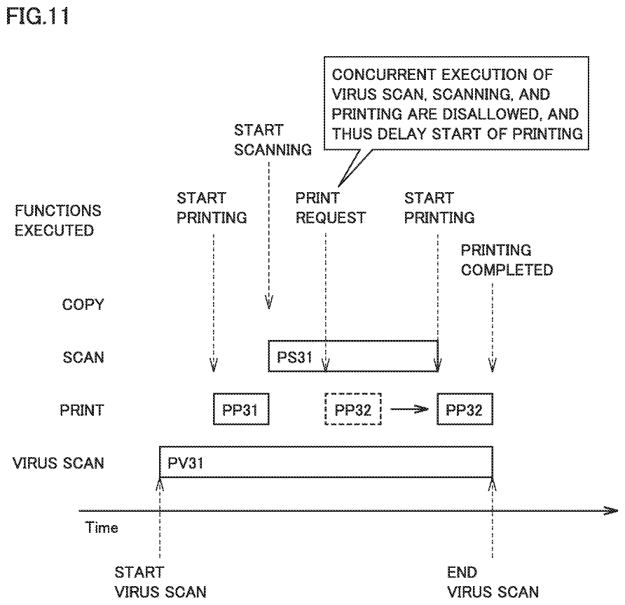

Under a given circumstance, CPU 20 adjusts functions which are concurrently executed. FIG. 11 is a diagram for illustrating another example of a mode of execution of the virus scan. FIG. 11 shows a process PS31 for the scanning function, processes PP31 and PP32 for the print function, and a process PV31 for the virus scan.

In image processing device 1, the number of functions which are executed concurrently with the virus scan is limited. For example, image processing device 1 may allow only a given number of functions (e.g., 1) to be executed during execution of the virus scan.

Initially, CPU 20 starts process PV31 for the virus scan. CPU 20 then starts process PP31 for the print function. There is no other functions being executed, and thus CPU 20 executes process PV31 and process PP31 in parallel.

After the end of process PP31, CPU 20 starts process PS31 in accordance with a scan request. There is no other functions being executed, and thus CPU 20 executes process PS31 and process PV31 in parallel.

Thereafter, upon receipt of a print request, CPU 20 defers the start of process PP32 in accordance with the request. This is because the print function is already being executed. After the completion of process PS31 for the scanning function, CPU 20 starts process PP32.

Although embodiments of the present invention have been described and illustrated in detail, it is clearly understood that the same is by way of illustration and example only and not limitation, the scope of the present invention should be interpreted by terms of the appended claims.

What is claimed is:

1. An image processing device, comprising:
a memory for storing a file; and
a circuitry that executes a virus scan on the file stored in the memory,
the memory storing information on priority levels set to one or more functions of the image processing device,
the circuitry being configured to determine a timing to execute a virus scan in accordance with the priority levels upon receipt of a request for execution of the virus scan and at least one of the one or more functions in parallel.

2. The image processing device according to claim 1,
wherein the one or more functions include a function whose productivity is guaranteed in the image processing device, and
wherein the information defines that the function whose productivity is guaranteed is not to be executed in parallel with the virus scan.

3. The image processing device according to claim 1, wherein:
the information on the priority levels includes numeric values; and
if a sum of the numeric values for the at least one of the one or more functions that are requested to be executed in parallel with the virus scan is less than a given threshold, the circuitry executes a process for implementing the at least one of the one or more functions in parallel with the virus scan.

4. The image processing device according to claim 3,
wherein the function whose productivity is guaranteed in the image processing device has a numeric value greater than or equal to the given threshold.

5. The image processing device according to claim 1, further comprising:
an input interface for receiving input,
wherein the circuitry generates the information on the priority levels in accordance with the input through the input interface.

6. The image processing device according to claim 1, further comprising:
a scanner; and
a printer, wherein:
the circuitry implements: a copy function, using the scanner and the printer; a scanning function, using the scanner; and a print function, using the printer, and
the circuitry does not execute the virus scan in parallel with at least one of the copy function, the scanning function, and the print function.

7. The image processing device according to claim 6,
wherein the circuitry preferentially executes at least one of the copy function, the scanning function, and the print function over the virus scan.

8. The image processing device according to claim 7,
wherein if the circuitry interrupts the virus scan by starting at least one of the copy function, the scanning function, and the print function, the circuitry resumes the virus scan after the function started by the circuitry ends.

9. A method for controlling an image processing device, comprising:
determining, whether the image processing device receives a request for execution of a virus scan on files stored in the image processing device and at least one of one or more functions of the image processing device in parallel;
when the image processing device receives the request for the execution of the virus scan and the at least one of the one or more functions in parallel, reading, from the memory, information on priority levels set to the at least one of the one or more functions; and
determining a timing to execute the virus scan in accordance with the priority levels.

10. A non-transitory computer-readable recording medium storing a computer program including an instruction for execution by a computer included in an image processing device which executes one or more functions, the image processing device including a memory storing a file,
the instruction causing the computer to perform:
determining whether the image processing device receives a request for execution of virus scan and at least one of the one or more functions of the image processing device in parallel;
when the image processing device receives the request for the execution of the virus scan and the at least one of the one or more functions in parallel, reading, from the memory, information on priority levels set to the at least one of the one or more functions; and
determining a timing to execute the virus scan in accordance with the priority levels.

11. The recording medium according to claim 10,
wherein the one or more functions includes a function whose productivity is guaranteed in the image processing device, and
the information defines that the function whose productivity is guaranteed is not to be executed in parallel with the virus scan.

12. The recording medium according to claim 10, wherein:
the information on the priority levels includes numeric values, and
if a sum of the numeric values of the at least one of the one or more functions that are requested to be executed in parallel with the virus scan is less than a given threshold, the instruction causes the computer to execute a process for implementing the at least one of the one or more functions in parallel with the virus scan.

13. The recording medium according to claim 12,
wherein the function whose productivity is guaranteed in the image processing device has a numeric value greater than or equal to the given threshold.

14. The recording medium according to claim 10,
wherein the image processing device includes an input interface for receiving input, and
the instruction causes the computer to generate the information on the priority levels, in accordance with the input through the input interface.

15. The recording medium according to claim 10,
wherein the image processing device includes a scanner and a printer,
the scanner and the printer implement a copy function,
the scanner implements a scanning function,
the printer implements a print function, and
the instruction causes the computer to avoid execution of the virus scan in parallel with at least one of the copy function, the scanning function, and the print function.

16. The recording medium according to claim 15,
wherein the instruction causes the computer to preferentially execute at least one of the copy function, the scanning function, and the print function over the virus scan.

17. The recording medium according to claim 16,
wherein if the virus scan is interrupted by starting at least one of the copy function, the scanning function, and the print function, the instruction causes the computer to resume the virus scan after the function ends.
